(19) United States
(12) Patent Application Publication
(10) Pub. No.: US 2026/0245078 A1
(43) Pub. Date: Aug. 20, 2026

(54) SYSTEMS AND METHODS FOR MULTI-PARTY AUTHENTICATION USING RELATIVISTIC ZERO-KNOWLEDGE PROOFS IN JOINT ACCOUNT TRANSACTIONS AND DELEGATED TRANSACTIONS

(71) Applicant: JPMORGAN CHASE BANK, N.A., New York, NY (US)

(72) Inventors: Yao MA, Guangdong (CN); Kaushik CHAKRABORTY, Singapore (SG); Jefferson CHU, Singapore (SG); Omar AMER, New York, NY (US); Kaiyan SHI, Greenbelt, MD (US); Lim Ci WEN, Singapore (SG); Marco PISTOIA, New York, NY (US)

(21) Appl. No.: 19/058,645

(22) Filed: Feb. 20, 2025

(51) Int. Cl. G06Q 20/38; G06Q 20/40

(52) U.S. Cl. CPC G06Q 20/38215; G06Q 20/401

(57) ABSTRACT

A method may include: receiving a transaction involving a joint account; receiving an identification of a plurality of clients associated with the joint account; generating synchronized correlated challenges based on an underlying mathematical hardness assumption for each of the client electronic devices; sending the synchronized correlated challenges to each client electronic device; receiving a response from each client electronic device, wherein each response is derived from a share of a private key and shared random information using the underlying mathematical hardness assumption, and includes a timestamp from a verification electronic device; verifying that the challenges and the responses are consistent with a mathematical relation between the challenges and responses and that the timestamps indicate receipt within a time window, wherein the mathematical relation is derived from the underlying mathematical hardness assumption; returning an authorization pass message to the initiating client electronic device; and executing the transaction.

### BACKGROUND OF THE INVENTION

### 1. Field of the Invention

Embodiments relate to systems and methods for multi-party authentication using relativistic zero-knowledge proofs in joint account transactions and delegated transactions.

### 2. Description of the Related Art

Often, multiple account holders can share access and control over a single financial account. Joint accounts are common in various financial settings, such as personal banking, business partnerships, or family finances. When larger withdrawals or transfers happen, it normally requires all account holders'approval with these transactions.

This, however, presents a security risk. For example, if one account holder's credentials are compromised, an attacker could potentially manipulate the approval process, especially if the attacker can coerce or deceive the other account holders.

Similarly, an account holder may authorize a third party to conduct transactions on behalf of the account holder. This may involve granting specific permissions to another supplementary account holder to perform certain actions using the primary account holder's credentials or authority. This can be particularly useful in various financial and blockchain applications, where users want to simplify processes or outsource transaction management. This also, however, presents a security risk, as if the credentials or authorization tokens used by the supplementary account are compromised, an unauthorized party could gain access to the account and perform transactions. Also, the supplementary accounts might exceed their authorized scope, either intentionally or accidentally, leading to unauthorized transactions.

### SUMMARY OF THE INVENTION

Systems and methods for multi-party authentication using relativistic zero-knowledge proofs in joint account transactions and delegated transactions are disclosed. According to one embodiment, a method may include: receiving, at an authorization computer program executed by an authorization server, a transaction involving a joint account from an initiating client electronic device; receiving, by the authorization computer program, an identification of a plurality of clients associated with the joint account; instructing, by the authorization computer program, the plurality of clients to connect their client electronic devices to one of a plurality of verification electronic devices; generating, by the authorization computer program, a set of synchronized correlated challenges based on an underlying mathematical hardness assumption for each of the client electronic devices; sending, by the authorization computer program, the set of synchronized correlated challenges to each client electronic device via the verification electronic device to which the client electronic device is connected; receiving, by the authorization computer program, a response from each client electronic device via the verification electronic device to which the client electronic device is connected, wherein each response is derived from a share of a private key and shared random information using the underlying mathematical hardness assumption, and includes a timestamp from the verification electronic device; verifying, by the authorization computer program, that the challenges and the responses are consistent with a mathematical relation between the challenges and responses and that the timestamps indicate receipt within a time window, wherein the mathematical relation is derived from the underlying mathematical hardness assumption; returning, by the authorization computer program, an authorization pass message to the initiating client electronic device; and executing the transaction.

In one embodiment, the underlying mathematical hardness assumption comprises the Short Integer Solution Problem, the Subset Sum Problem, the 3-SAT problem, or the 3-Coloring Graph Problem.

In one embodiment, the responses comprise a commitment of the share of the private key committed using the shared random information.

In one embodiment, the method may also include retrieving, by the authorization computer program, a public key for the joint account; and decrypting, by the authorization computer program, the responses using the public key.

In one embodiment, the transaction comprises a financial transaction.

In one embodiment, the transaction comprises an access transaction.

In one embodiment, the time window is based on a physical distance between the client electronic devices and the verifier electronic devices to which the client electronic devices are connected.

According to another embodiment, a method may include: receiving, at an authorization computer program executed by an authorization server, a transaction involving an account from a delegated account holder; receiving, by the authorization computer program, a primary account key for the account; instructing, by the authorization computer program, a primary account holder for the account and the delegated account holder to connect their electronic devices to one of a plurality of verification electronic devices; generating, by the authorization computer program, a set of synchronized correlated challenges based on an underlying mathematical hardness assumption for each of the electronic devices; sending, by the authorization computer program, the set of synchronized correlated challenges to each electronic device via the verification electronic device to which the electronic device is connected; receiving, by the authorization computer program, a response from each electronic device via the verification electronic device to which the electronic device is connected, wherein the response of the primary account holder commits to a primary account key using a corresponding shared delegated account local key, and the response of delegated account holder is derived from its corresponding shared delegated account local key based on the underlying mathematical hardness assumption, and includes a timestamp from the verification electronic device; verifying, by the authorization computer program, that the challenges and responses are consistent with a mathematical relation that is derived from the underlying mathematical hardness assumption between the challenges and responses and that the timestamps indicate receipt within a time window; returning, by the authorization computer program, an authorization pass message to the electronic devices; and executing the transaction.

In one embodiment, the method may also include: retrieving, by the authorization computer program, a public key for the account; and decrypting, by the authorization computer program, the responses using the public key.

In one embodiment, the transaction comprises a financial transaction.

In one embodiment, the transaction comprises an access transaction.

In one embodiment, the time window is based on a physical distance between the electronic devices and the verifier electronic device to which the electronic device is connected.

According to another embodiment, a method may include: receiving, at an authorization computer program executed by an authorization server, a transaction involving an account from a delegated account holder; receiving, by the authorization computer program, a primary account key for the account; instructing, by the authorization computer program, a primary account holder for the account and the delegated account holder to connect their electronic devices to one of a plurality of verification electronic devices; generating, by the authorization computer program, a set of synchronized correlated challenges based on an underlying mathematical hardness assumption for each of the electronic devices; sending, by the authorization computer program, the set of synchronized correlated challenges to each electronic device via the verification electronic device to which the electronic device is connected; receiving, by the authorization computer program, a response from each electronic device via the verification electronic device to which the electronic device is connected, wherein the response of the primary account holder commits to a primary account key using a corresponding shared delegated account local key, and the response of delegated account holder is derived from its corresponding shared delegated account local key based on the underlying mathematical hardness assumption, and includes a timestamp from the verification electronic device; verifying, by the authorization computer program, that the challenges and responses are consistent with a mathematical relation that is derived from the underlying mathematical hardness assumption between the challenges and responses and that the timestamps indicate receipt within a time window; returning, by the authorization computer program, an authorization pass message to the electronic devices; and executing the transaction.

In one embodiment, the underlying mathematical hardness assumption comprises the Short Integer Solution Problem, the Subset Sum Problem, the 3-SAT problem, or the 3-Coloring Graph Problem.

In one embodiment, the method may also include: retrieving, by the authorization computer program, a public key for the account; and decrypting, by the authorization computer program, the responses using the public key.

In one embodiment, the transaction comprises a financial transaction.

In one embodiment, the transaction comprises an access transaction.

In one embodiment, the time window is based on a physical distance between the electronic devices and the verifier electronic device to which the electronic device is connected.

According to another embodiment, a system may include: an authorization electronic device executing an authorization computer program; a plurality of verification electronic devices executing verifier computer programs; and a plurality of client electronic devices, each client executing a client computer program. The authorization computer program receives a transaction involving a joint account from an initiating client electronic device of the plurality of client electronic devices; the authorization computer program identifies a plurality of clients associated with the joint account; the authorization computer program instructs the plurality of clients to connect their client electronic devices to one of the plurality of verification electronic devices; the authorization computer program generates a set of synchronized correlated challenges based on an underlying mathematical hardness assumption for each of the client electronic devices; the authorization computer program sends the set of synchronized correlated challenges to each client electronic device via the verification electronic device to which the client electronic device is connected; each of the client electronic devices generates a response to the set of synchronized correlated challenges, wherein each response is derived from a share of a private key and shared random information using the underlying mathematical hardness assumption; each of the client electronic devices communicates the response to the verification electronic device to which the client electronic device is connected; each of verification electronic device communicates the response to the authorization computer program with a timestamp indicating when the response was received; the authorization computer program verifies that the challenges and responses are consistent with a mathematical relation between the challenges and responses and that the timestamps indicate receipt within a time window, wherein the mathematical relation is derived from the underlying mathematical hardness assumption; the authorization computer program returns an authorization pass message to the initiating client electronic device; and the authorization computer program causes the transaction to be executed.

In one embodiment, the underlying mathematical hardness assumption comprises the Short Integer Solution Problem, the Subset Sum Problem, the 3-SAT problem, or the 3-Coloring Graph Problem.

In one embodiment, the responses comprise a commitment of the share of the private key committed using the shared random information.

In one embodiment, the authorization computer program retrieves a public key for the joint account; and the authorization computer program decrypts the responses using the public key.

In one embodiment, the transaction comprises a financial transaction.

In one embodiment, the transaction comprises an access transaction.

In one embodiment, the time window is based on a physical distance between the client electronic devices and the verifier electronic device to which the client electronic devices are connected.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for multi-party authentication using relativistic zero-knowledge proofs in joint account transactions according to an embodiment.

FIG. 2 depicts a method for data preparation for multi-party authentication using relativistic zero-knowledge proofs in joint account transactions according to an embodiment.

FIG. 3 depicts a method for multi-party authentication using relativistic zero-knowledge proofs in joint account transactions according to an embodiment.

FIGS. 4A and 4B depict a method for multi-party authentication using relativistic zero-knowledge proofs in joint account transactions according to an embodiment.

FIG. 5 depicts a system for multi-party authentication for delegated transactions using relativistic zero-knowledge proofs according to an embodiment.

FIG. 6 depicts a method of data preparation for multi-party authentication for delegated transactions using relativistic zero-knowledge proofs according to an embodiment.

FIG. 7 depicts a method for multi-party authentication for delegated transactions using relativistic zero-knowledge proofs according to an embodiment.

FIGS. 8A and 8B depict a method for multi-party authentication for delegated transactions using relativistic zero-knowledge proofs according to an embodiment.

FIG. 9 depicts an exemplary computing system for implementing aspects of the present disclosure.

### DETAILED DESCRIPTION OF PREFERRED EMBODIMENTS

Embodiments relate generally to systems and methods for multi-party authentication using relativistic zero-knowledge proofs in joint account transactions and delegated transactions.

According to an embodiment, for a joint account shared across multiple clients, a secret may be distributed across all clients. Transactions require authentication from all clients, and the secrets are committed during authentication protocol. Advantages include client secrets are distributed and preserved, and client secrets are secure against skimming attacks.

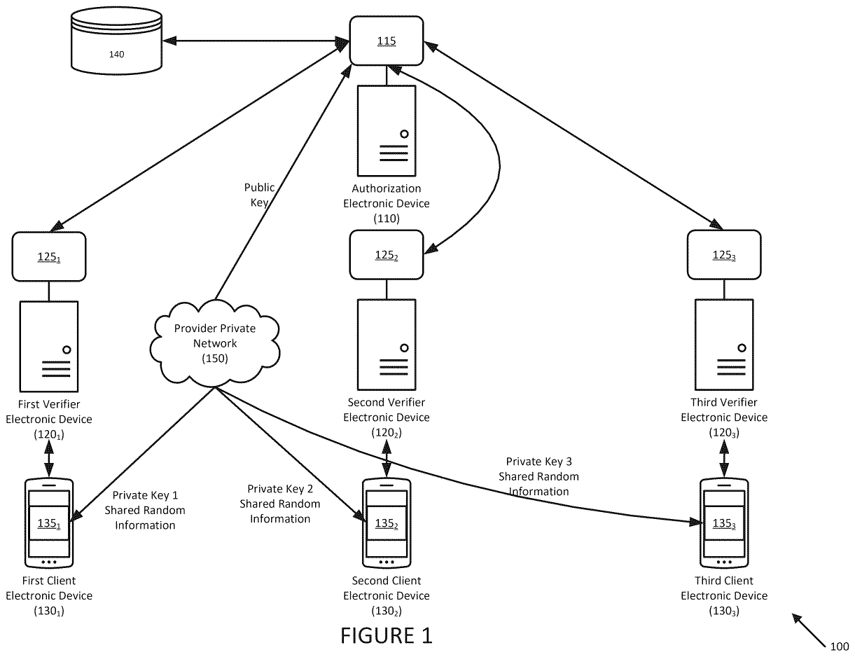

Referring to FIG. 1, a system for multi-party authentication using relativistic zero-knowledge proofs in joint account transactions is disclosed according to an embodiment.

System 100 may include authorization electronic device 110, which may be a server (e.g., physical and/or cloud-based), a computer (e.g., workstation, desktop, laptop, notebook, tablet, etc.), etc. Authorization electronic device 110 may execute authorization computer program that may authorize clients using relativistic zero-knowledge proofs.

System 100 may further include a plurality of verifier electronic devices, such as first verifier electronic device 120₁, second verifier electronic device 120₂, and third verifier electronic device 120₃. Although three verifier electronic devices 120 are depicted in FIG. 1, it should be noted that a greater number of verifier devices, or a fewer number of verifier devices, may be provided. Each verifier electronic device 120 may execute a verifier computer program (e.g., first verifier computer program 125₁, second verifier computer program 125₂, third verifier computer program 125₃. Verifier computer programs 125₁, 125₂, 125₃, may communicate with authorization computer program 115.

Examples of verifier electronic devices 120 may include automated teller machines, point of sale device, other card readers, etc.

Each verifier electronic device 120 may interface with a client electronic device (e.g., first client electronic device 130₁, second client electronic device 130₂, third client electronic device 130₃. Client electronic devices 130 may include computers, smart devices, IoT devices, smart cards, fobs, hardware tokens, etc. Although three client electronic devices 130 are depicted in FIG. 1, it should be noted that a greater number of client devices, or a fewer number of client devices, may be provided. Each client electronic device may execute a client computer program (e.g., first client computer program 135₁, second client computer program 135₂, third client computer program 135₃.

In one embodiment, clients may be clients of the providing institution, such as individuals that share a joint account. The joint account may require a joint decision for taking an action. Examples of accounts may include financial accounts, access accounts, content accounts, etc.

In one embodiment, each client electronic device may store a private key and random information. The private key and random information may be provided by a providing institution, such as a financial institution.

System 100 may further include database 140 that may store information, such as a public key for a joint account.

System 100 may include provider private network 150 for the providing institution. Provider private network 150 may distribute public key to authorization computer program 115, where it may be stored in database 140.

Provider private network 150 may also derive and distribute shares of a private key, and shared random information, to client electronic devices 130 using a secret sharing scheme, such as XOR secret sharing, additive secret sharing, visual cryptography, one-time pad with multiple keys, etc. For example, during setup, prover private network 150 may distribute a share of the client private key, along with shared random information, to each client electronic device 130.

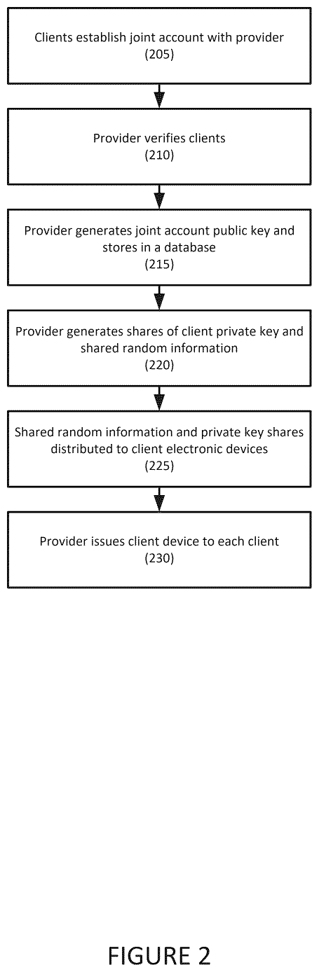

Referring to FIG. 2, a method for data preparation for multi-party authentication using relativistic zero-knowledge proofs in joint account transactions is disclosed according to an embodiment. In step 205, a plurality of clients, such as individuals that share a joint account, may establish a joint account with a provider, such as a financial institution, a service provider, etc. In one embodiment, the account may be a financial account, an account that provides access to a good or service, account that provides access to an area or content, etc.

In step 210, the provider may verify the clients. For example, the provider may verify client credentials, such as an identity, a digital identity, etc.

In step 215, following a successful verification, the provider may generate a joint account public key and a private key for the joint account, and may announce the public key (e.g., distribute the public key to a database that may be accessed by the authorization server). The joint account public key and private key may be based on an underlying mathematical hardness assumption that is being leveraged in the protocol, such as the Short Integer Solution Problem, the Subset Sum Problem, the 3-SAT problem, the 3-Coloring Graph Problem, etc.

In step 220, the provider may coordinate client private key generation and client private key share derivation. For example, the provider may derive shares of a client private key for each client using a secret sharing scheme, such as XOR secret sharing, additive secret sharing, visual cryptography, one-time pad with multiple keys, etc.

The provider may also generate shared random information. The shared random information may be based on the underlying mathematical hardness assumption that is being leveraged, such as the Short Integer Solution Problem, the Subset Sum Problem, the 3-SAT problem, the 3-Coloring Graph Problem, etc.

In general, the shared random information may be a random, or pseudo-random string, with certain size that is derived from a cryptographic-secure random source. The shared random information may be different for each client.

Note that the shared random information may be periodically refreshed or regenerated using, for example, a deterministic polynomial-time algorithm as pseudo-random generator.

In step 225, the provider may distribute the shared random information and the client private key shares to the client electronic devices. Each client electronic device may store its client private key share and the shared random information in memory. For example, the client devices may store the client private key shares and shared random information in a secure element or similar.

In step 230, if not already done so, the provider may issue one of the client devices to each client.

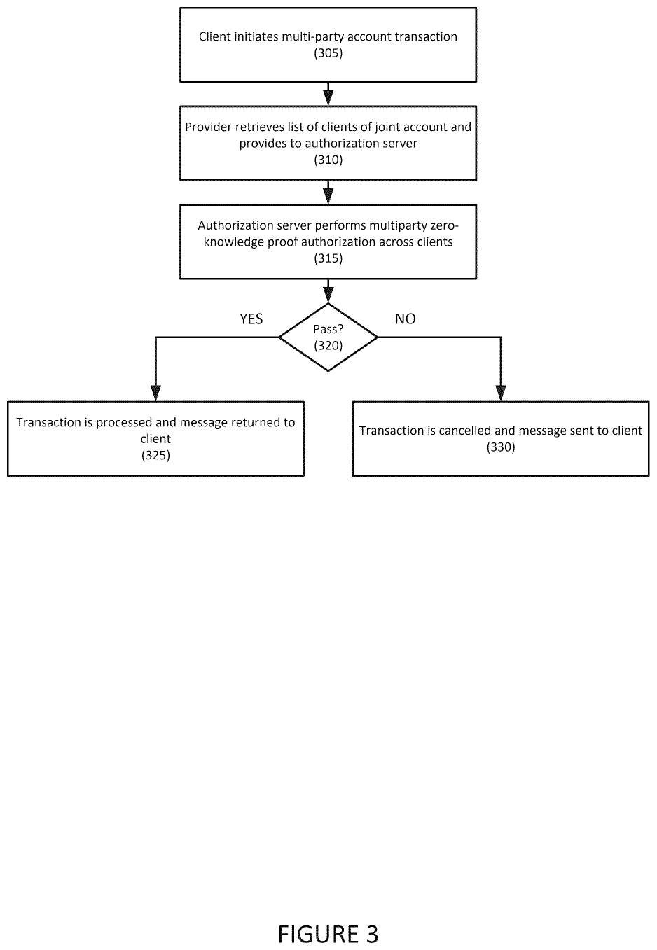

Referring to FIG. 3, a method for multi-party authentication using relativistic zero-knowledge proofs in joint account transactions is disclosed according to an embodiment.

In step 305, one of the clients may initiate a transaction involving a joint account that requires joint authorization. The transaction may be a financial transaction, a request for access transaction, etc. Certain transactions may require joint authorization, while others may not. For example, for a deposit transaction, any account holder may independently initiate the deposit without joint authorization. For withdrawals and transfers, any account holder may initiate a withdrawal or transfer unless there are restrictions in place that require joint authorization.

In step 310, the provider may retrieve an identification of clients associated with the joint account and may provide the identification to an authorization server.

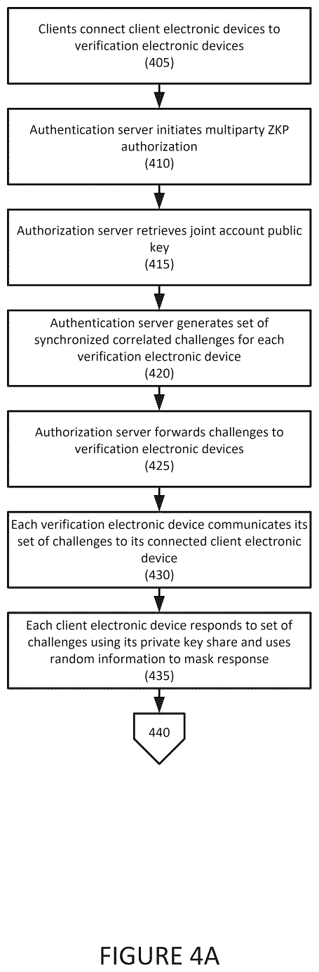

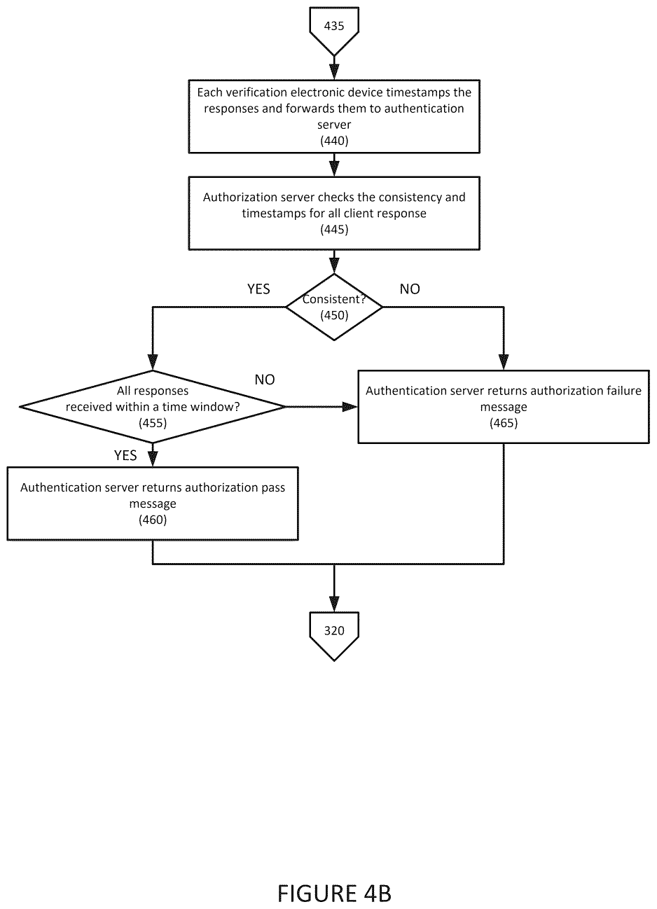

In step 315, the authorization server may perform multiparty zero-knowledge proof authorization across the clients. An example of such authentication is provided in FIGS. 4A and 4B.

Referring to FIGS. 4A and 4B, a method for multi-party authentication using relativistic zero-knowledge proofs in joint account transactions is disclosed according to an embodiment.

In step 405, the clients may be instructed to present or connect their client electronic devices to one of a plurality of verification electronic devices. For example, the clients may identify itself by presenting a machine-readable code (e.g., a QR code or similar), making near field communication, or may insert the client electronic device into an interface.

Each verification electronic device may inform the authorization server when a client device is connected.

In step 410, the authorization server may initiate multiparty zero-knowledge proof authorization with the client electronic devices.

In step 415, the authorization server may retrieve the joint account public key for the joint account from a database.

In step 420, the authorization server may generate a set of synchronized correlated challenges for each verification electronic device. The form of the challenge may depend on the underlying mathematical hardness assumption that is being leveraged in the protocol. In general, the challenges may be derived from the public key, and the way of generating responses by clients are based on the problem being leveraged. As a result, the challenge messages may be sampled from a challenge domain, instead of from a fixed message.

In step 425, the authorization server may forward the sets of challenges to the verification electronic devices.

In step 430, each verification electronic device may communicate its set of challenges to its connected client electronic device, for example, by NFC, machine-readable code, etc.

In step 435, each client electronic device may respond to the set of challenges via a predetermined function that commits to its client private key share using the shared random information using, for example, the Hamiltonian Cycle Commitment Scheme, Sigma Protocol-based Commitment Scheme, etc. The predetermined function may depend on the underlying mathematical hardness assumption that is being leveraged in the protocol, such as the Short Integer Solution Problem, the Subset Sum Problem, the 3-SAT problem, the 3-Coloring Graph Problem, etc.

In step 440, as each response is received, the verification electronic device may timestamp the response, and may forward the response with the timestamp to the authorization server.

In step 445, the authorization server may check the consistency and timestamps of the responses. For example, the authorization server may check whether each round is completed within a certain time based on the timestamp. In addition, the authorization server may perform a verification function, upon the public key, variables of challenges and responses, to determine if the authentication pass or fails. The authorization server may use the public key to decrypt the responses all together. The shared random information may be used to establish the correlation of the responses generated by clients.

If, in step 450, the challenges and responses are consistent with a mathematical relation that is derived from the mathematical hardness assumption, in step 455, the responses are checked to see if they are all received within a time window. Mathematical relations describe specific implications, reductions or structures that arise from the mathematical hardness assumption. These relations typically provide formal ways of using the mathematical hardness assumption in security proofs and application designs in cryptography. For example, it is widely believed that latticed-based problems like the Short Integer Solution, Learning With Errors, etc., are computationally hard, even for quantum computers (i.e., in the scope of post-quantum cryptography). Because the encryption scheme is designed based on these problems, breaking the cryptographic scheme is equivalent to solving latticed-based problems. That is, if one or more adversaries, who pretend to be the clients, can produce a valid response without knowing the underlying secret shares and/or shared random information within the time window, they can solve latticed-based problems efficiently. It results in breaking the encryption and will violate the assumed hardness.

Thus, a mathematical relation is derived from a hardness assumption when an instance of a hard problem can be mapped to another problem, function, or construction in a structured way. This often follows the approaches such as, complexity theoretic reductions, security proofs in cryptography, approximation hardness and probabilistic formulation of indistinguishability relations.

In one embodiment, the time window may be based on the minimal physical distance Dist between any verifier-client pairs. For example, the maximum tolerable time for a client to reply to a challenge may be determined from the following equations: tₜₕᵣₑₛ=Dist/c and t_{exec}≤tₜₕᵣₑₛ, where c is the speed of light, and t_{exec} is the execution time to generate and proceed a response depending on implementation on hardware/software.

If the responses are all received within the time window, in step 460, the authorization server may return an authorization pass message to the client electronic device that initiated the transaction. The transaction may then be executed.

If the challenges and responses are not consistent, or all responses are not received within the time window, in step 465, the authorization server may return an authorization failure message to the client electronic device that initiated the transaction.

Referring again to FIG. 3, in step 320, if the authorization passed, in step 325, the transaction is processed, and a success message may be returned to the client that initiated the transaction.

In one embodiment, the success message and the transaction may be provided to a downstream system that may execute the transaction.

If the authorization failed, in step 330, the transaction may be cancelled, and a failure message may be returned to the client that initiated the transaction.

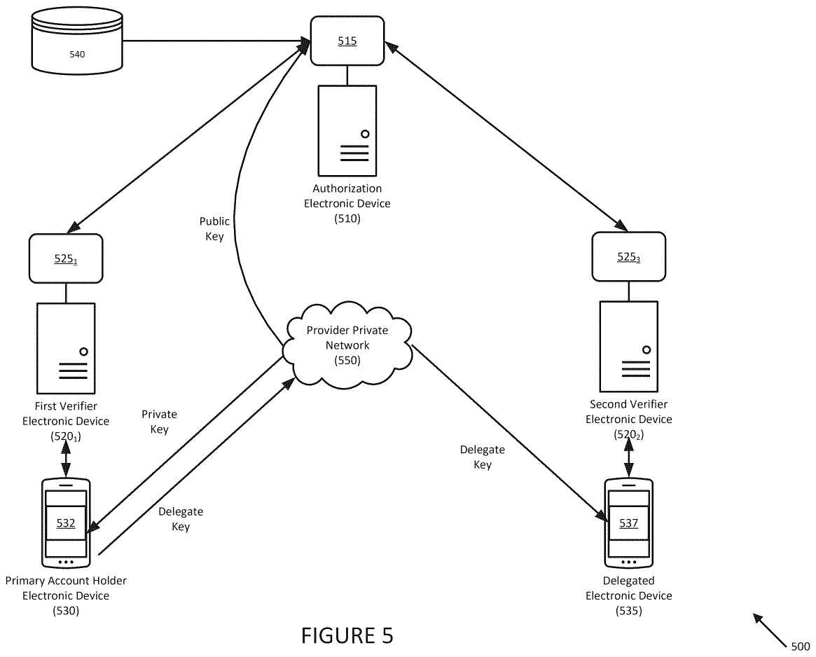

Referring to FIG. 5, a system for multi-party authentication for delegated transactions using relativistic zero-knowledge proofs is disclosed according to an embodiment. System 500 may include authorization electronic device 510 that may execute authorization computer program 515. These may be similar to elements 110 and 115, above.

System 500 may further include verifier electronic devices 520 executing verifier computer programs 525. These may be similar to elements 120 and 125, above.

System 500 may further include primary account holder electronic device 530 and delegated electronic device 535. These may be similar to elements 130, above.

Primary account holder electronic device 530 and delegated electronic device 535 may execute primary account holder electronic device computer program 532 and delegated electronic device computer program 537, respectively.

System 500 may further include provider private network 550 for a provider. Provider private network 550 may generate a public key and provide it to authorization computer program 515. It may further generate primary account private key and may distribute a delegate key to delegate electronic device 535.

System 500 may further include database 540 that may store information, such as the public key.

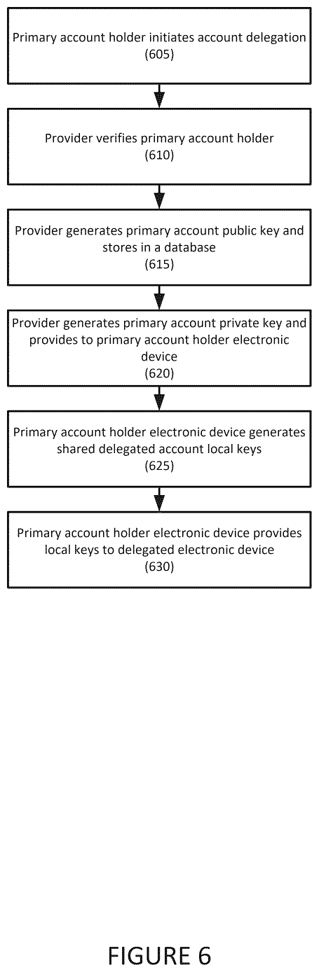

Referring to FIG. 6, a method of data preparation for multi-party authentication for delegated transactions using relativistic zero-knowledge proofs is disclosed according to an embodiment.

In step 605, a primary account holder may initiate account delegation. For example, the primary account holder may submit a request for account delegation to a provider, such as a financial institution.

In step 610, the provider may verify the primary account holder. For example, the provider may verify the primary account holder's credentials, such as an identity, a digital identity, etc.

In step 615, following a successful verification, the provider may generate a primary account public key and may store the primary account public key in a database.

In step 620, the provider may generate a primary account private key and may provide the primary account private key to a primary account holder electronic device. The primary account holder electronic device may store the primary account private key in secure storage.

In step 625, the primary account holder electronic device may generate one or more shared delegated account local keys based on the primary account key. For example, the primary account holder may distribute a delegate key to the delegated electronic device. The form of the delegate key may differ case by case. If more than one delegated account is assigned, the primary account holder may generate multiple delegated account local keys.

In step 630, the primary account holder electronic device may provide the local keys to a delegated electronic device. The delegated electronic device may store the delegated account local keys in secure storage.

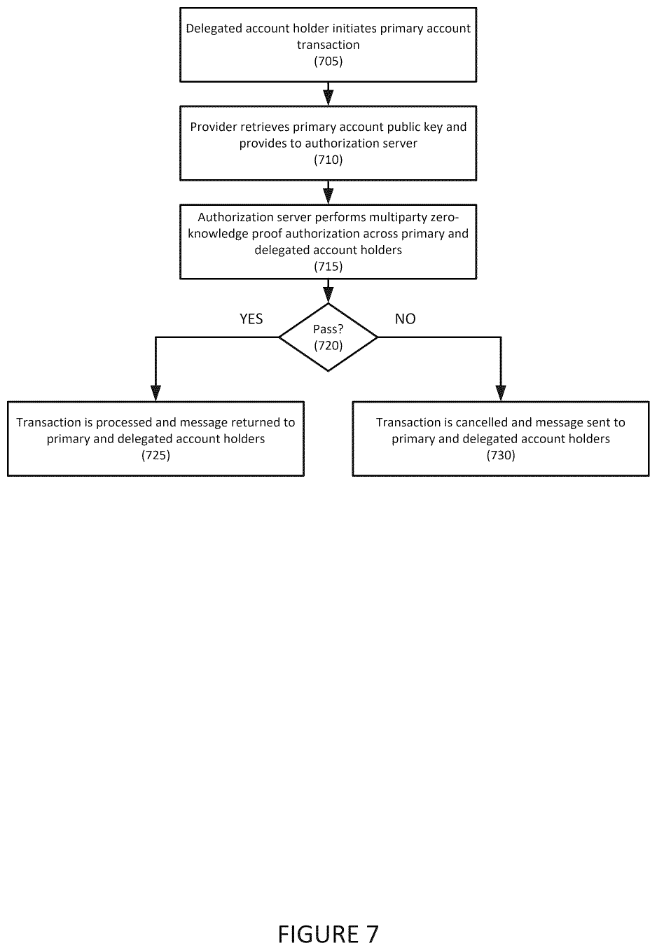

Referring to FIG. 7, a method for multi-party authentication for delegated transactions using relativistic zero-knowledge proofs is disclosed according to an embodiment.

In step 705, the delegated account holder may initiate a transaction involving the primary account. The transaction may be a financial transaction, a request for access transaction, etc.

In step 710, the provider may retrieve the primary account key for the primary account and may provide it to an authorization server.

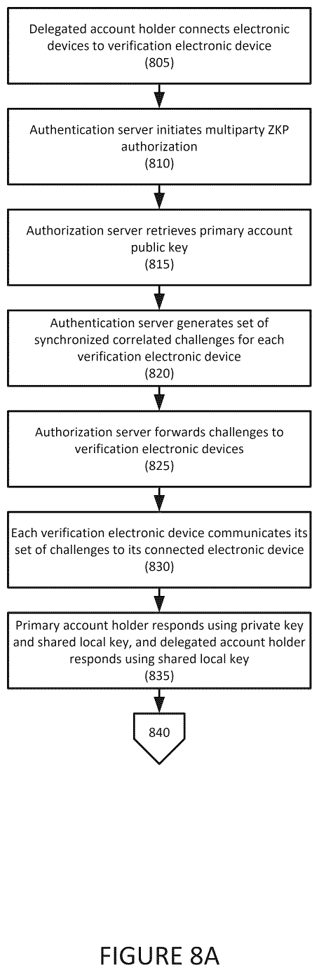

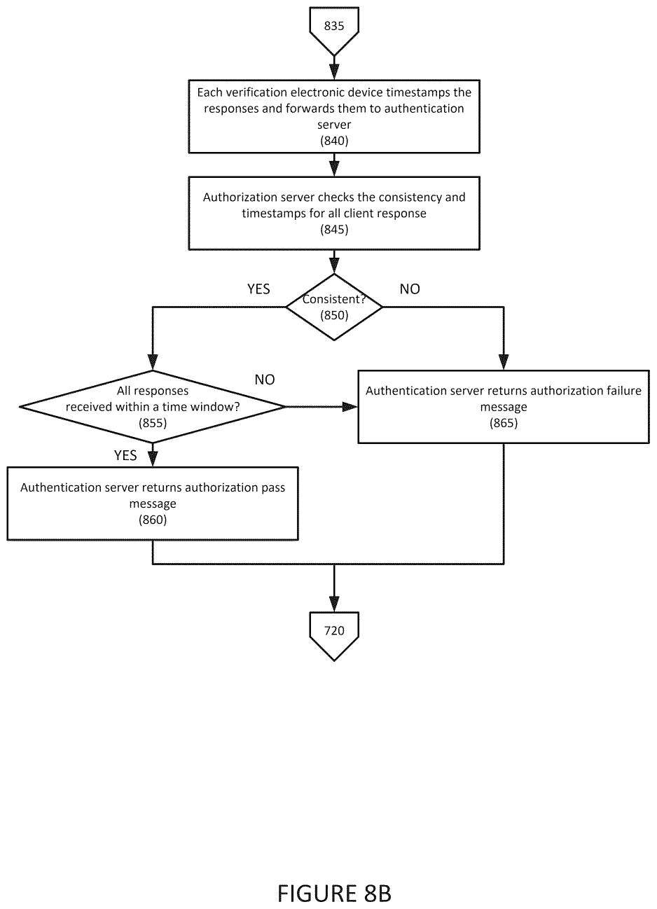

In step 715, the authorization server may perform multi-party authentication using relativistic zero-knowledge proofs across the primary and delegated account holders. An example of such authentication is provided in FIGS. 8A and 8B.

Referring to FIGS. 8A and 8B, a method for multi-party authentication for delegated transactions using relativistic zero-knowledge proofs is disclosed according to an embodiment.

In step 805, the delegated account holder may be instructed to present or connect its electronic device to one of a plurality of verification electronic device, and the delegate account holder may present a QR code, an NFC code, or may insert its token to the verification electronic device. The verification electronic device may inform an authorization server when the delegated account holder electronic device is connected. The primary account holder may also be notified and instructed to connect its electronic device to a verification electronic device.

In step 810, the authorization server may initiate multiparty zero-knowledge proof authorization with the client electronic devices.

In step 815, the authorization server may retrieve the primary account public key for the joint account from a database.

In step 820, the authorization server may generate a set of synchronized correlated challenges for each verification electronic device. The form of the challenge may depend on the underlying mathematical hardness assumption that is being leveraged in the protocol, such as the Short Integer Solution Problem, the Subset Sum Problem, the 3-SAT problem, the 3-Coloring Graph Problem, etc. In general, the challenges may be derived from the public key, and the way of generating responses are based on the problem being leveraged. As a result, the challenge messages may be sampled from a challenge domain, instead of a fixed message.

In step 825, the authorization server may forward the sets of challenges to the verification electronic devices.

In step 830, each verification electronic device may communicate its set of challenges to its connected client electronic device, i.e., the primary account holder electronic device and the delegated electronic device.

In step 835, the primary account holder may respond to the challenge via a first predetermined function that commits to the primary account private key using the shared local key using, for example, Hamiltonian Cycle Commitment Scheme, Sigma Protocol-based Commitment Scheme, etc., and the delegated account holder may respond to the challenge via a second predetermined function that may be different from the first using the shared local key. The response to the challenge may depend on the underlying mathematical hardness assumption that is being leveraged, such as the Short Integer Solution Problem, the Subset Sum Problem, the 3-SAT problem, the 3-Coloring Graph Problem, etc.

In step 840, as each response is received, the verification electronic device may timestamp the response, and may forward the response with the timestamp to the authorization server.

In step 845, the authorization server may check the consistency and timestamps of the responses. For example, the authorization server may check whether each round is completed within a certain time based on the timestamp. In addition, the authorization server may perform a verification function, upon the public key, variables of challenges and responses, to determine if the authentication pass or fails. The authorization server may use the public key to decrypt the responses all together. The shared random information may be used to establish the correlation of the responses generated by clients.

If, in step 850, the challenges and responses are consistent with the underlying mathematical relations that are derived from the mathematical hardness assumption, and in step 855, the responses are checked to see if they are all received within a time window. In one embodiment, the time window may be based on the minimal physical distance Dist between any verifier-client pairs. For example, the maximum tolerable time for a client to reply to a challenge may be determined from the following equations: tₜₕᵣₑₛ=Dist/c and t_{exec}≤tₜₕᵣₑₛ, where c is the speed of light, and t_{exec} is the execution time to generate and proceed a response depending on implementation on hardware/software

If the responses are all received within the time window, in step 860, the authorization server may return an authorization pass message to the client electronic device that initiated the transaction. The transaction may then be executed.

If the challenges and responses are not consistent, or all responses are not received within the time window, in step 865, the authorization server may return an authorization failure message to the client electronic device that initiated the transaction.

Referring again to FIG. 7, in step 720, if the authentication passed, in step 725, the transaction is processed, and a success message may be returned to the primary and delegated account holders.

If the authentication failed, in step 730, the transaction may be cancelled, and a failure message may be returned to the primary and delegated account holders.

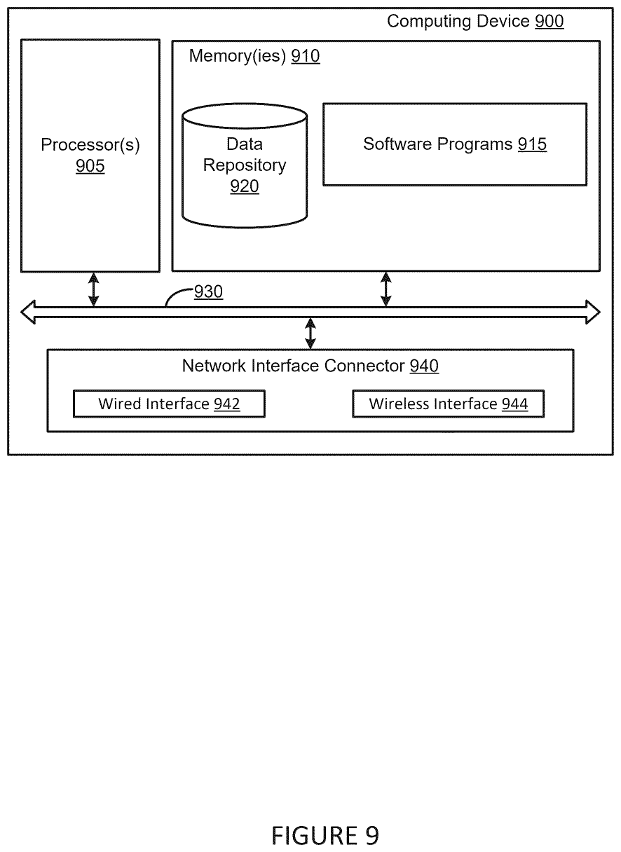

FIG. 9 depicts an exemplary computing system for implementing aspects of the present disclosure. FIG. 9 depicts exemplary computing device 900. Computing device 900 may represent the system components described herein. Computing device 900 may include processor 905 that may be coupled to memory 910. Memory 910 may include volatile memory. Processor 905 may execute computer-executable program code stored in memory 910, such as software programs 915. Software programs 915 may include one or more of the logical steps disclosed herein as a programmatic instruction, which may be executed by processor 905. Memory 910 may also include data repository 920, which may be nonvolatile memory for data persistence. Processor 905 and memory 910 may be coupled by bus 930. Bus 930 may also be coupled to one or more network interface connectors 940, such as wired network interface 942 or wireless network interface 944. Computing device 900 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

1. A method, comprising:
receiving, at an authorization computer program executed by an authorization server, a transaction involving a joint account from an initiating client electronic device;
receiving, by the authorization computer program, an identification of a plurality of clients associated with the joint account;
instructing, by the authorization computer program, the plurality of clients to connect their client electronic devices to one of a plurality of verification electronic devices;
generating, by the authorization computer program, a set of synchronized correlated challenges based on an underlying mathematical hardness assumption for each of the client electronic devices;
sending, by the authorization computer program, the set of synchronized correlated challenges to each client electronic device via the verification electronic device to which the client electronic device is connected;
receiving, by the authorization computer program, a response from each client electronic device via the verification electronic device to which the client electronic device is connected, wherein each response is derived from a share of a private key and shared random information using the underlying mathematical hardness assumption, and includes a timestamp from the verification electronic device;
verifying, by the authorization computer program, that the challenges and the responses are consistent with a mathematical relation between the challenges and responses and that the timestamps indicate receipt within a time window, wherein the mathematical relation is derived from the underlying mathematical hardness assumption;
returning, by the authorization computer program, an authorization pass message to the initiating client electronic device; and
executing the transaction.

2. The method of claim 1, wherein the underlying mathematical hardness assumption comprises the Short Integer Solution Problem, the Subset Sum Problem, the 3-SAT problem, or the 3-Coloring Graph Problem.

3. The method of claim 1, wherein the responses comprise a commitment of the share of the private key committed using the shared random information.

4. The method of claim 1, further comprising:
retrieving, by the authorization computer program, a public key for the joint account; and
decrypting, by the authorization computer program, the responses using the public key.

5. The method of claim 1, wherein the transaction comprises a financial transaction.

6. The method of claim 1, wherein the transaction comprises an access transaction.

7. The method of claim 1, wherein the time window is based on a physical distance between the client electronic devices and the verifier electronic devices to which the client electronic devices are connected.

8. A method, comprising:
receiving, at an authorization computer program executed by an authorization server, a transaction involving an account from a delegated account holder;
receiving, by the authorization computer program, a primary account key for the account;
instructing, by the authorization computer program, a primary account holder for the account and the delegated account holder to connect their electronic devices to one of a plurality of verification electronic devices;
generating, by the authorization computer program, a set of synchronized correlated challenges based on an underlying mathematical hardness assumption for each of the electronic devices;
sending, by the authorization computer program, the set of synchronized correlated challenges to each electronic device via the verification electronic device to which the electronic device is connected;
receiving, by the authorization computer program, a response from each electronic device via the verification electronic device to which the electronic device is connected, wherein the response of the primary account holder commits to a primary account key using a corresponding shared delegated account local key, and the response of delegated account holder is derived from its corresponding shared delegated account local key based on the underlying mathematical hardness assumption, and includes a timestamp from the verification electronic device;
verifying, by the authorization computer program, that the challenges and responses are consistent with a mathematical relation that is derived from the underlying mathematical hardness assumption between the challenges and responses and that the timestamps indicate receipt within a time window;
returning, by the authorization computer program, an authorization pass message to the electronic devices; and
executing the transaction.

9. The method of claim 8, wherein the underlying mathematical hardness assumption comprises the Short Integer Solution Problem, the Subset Sum Problem, the 3-SAT problem, or the 3-Coloring Graph Problem.

10. The method of claim 8, further comprising:
retrieving, by the authorization computer program, a public key for the account; and
decrypting, by the authorization computer program, the responses using the public key.

11. The method of claim 8, wherein the transaction comprises a financial transaction.

12. The method of claim 8, wherein the transaction comprises an access transaction.

13. The method of claim 8, wherein the time window is based on a physical distance between the electronic devices and the verifier electronic device to which the electronic device is connected.

14. A system, comprising:
an authorization electronic device executing an authorization computer program;
a plurality of verification electronic devices executing verifier computer programs; and
a plurality of client electronic devices, each client executing a client computer program;
wherein:
the authorization computer program receives a transaction involving a joint account from an initiating client electronic device of the plurality of client electronic devices;
the authorization computer program identifies a plurality of clients associated with the joint account;
the authorization computer program instructs the plurality of clients to connect their client electronic devices to one of the plurality of verification electronic devices;
the authorization computer program generates a set of synchronized correlated challenges based on an underlying mathematical hardness assumption for each of the client electronic devices;
the authorization computer program sends the set of synchronized correlated challenges to each client electronic device via the verification electronic device to which the client electronic device is connected;
each of the client electronic devices generates a response to the set of synchronized correlated challenges, wherein each response is derived from a share of a private key and shared random information using the underlying mathematical hardness assumption;
each of the client electronic devices communicates the response to the verification electronic device to which the client electronic device is connected;
each of verification electronic device communicates the response to the authorization computer program with a timestamp indicating when the response was received;
the authorization computer program verifies that the challenges and responses are consistent with a mathematical relation between the challenges and responses and that the timestamps indicate receipt within a time window, wherein the mathematical relation is derived from the underlying mathematical hardness assumption;
the authorization computer program returns an authorization pass message to the initiating client electronic device; and
the authorization computer program causes the transaction to be executed.

15. The system of claim 14, wherein the underlying mathematical hardness assumption comprises the Short Integer Solution Problem, the Subset Sum Problem, the 3-SAT problem, or the 3-Coloring Graph Problem.

16. The system of claim 14, wherein the responses comprise a commitment of the share of the private key committed using the shared random information.

17. The system of claim 14, wherein the authorization computer program retrieves a public key for the joint account; and
the authorization computer program decrypts the responses using the public key.

18. The system of claim 14, wherein the transaction comprises a financial transaction.

19. The system of claim 14, wherein the transaction comprises an access transaction.

20. The system of claim 14, wherein the time window is based on a physical distance between the client electronic devices and the verifier electronic device to which the client electronic devices are connected.
